(19) United States
(12) Patent Application Publication
(10) Pub. No.: US 2015/0227859 A1
(43) Pub. Date: Aug. 13, 2015

(54) SYSTEMS AND METHODS FOR CREATING A FORECAST UTILIZING AN ENSEMBLE FORECAST MODEL

(71) Applicant: The Procter & Gamble Company, Cincinnati, OH (US)

(72) Inventor: Daniel E. Ames, II, Morrow, OH (US)

(21) Appl. No.: 14/594,198

(22) Filed: Jan. 12, 2015

Related U.S. Application Data
(60) Provisional application No. 61/938,756, filed on Feb. 12, 2014.

(51) Int. Cl. G06Q 10/04; G06F 17/18

(52) U.S. Cl. CPC G06Q 10/04; G06F 17/18

(57) ABSTRACT

Included are embodiments for creating a forecast utilizing an ensemble forecast model. These embodiments include receiving a selection of a plurality of model families to utilize for forecasting, receiving a selection of a plurality of models to utilize for forecasting, and determining a variable of each of the plurality of models. Some embodiments include substantially simultaneously optimizing the variable of each of the plurality of models, combining each of the plurality of models into an ensemble model, the ensemble model comprising a plurality of ensemble model variables, and weighting each of the plurality of models according to a predetermined criterion. Still some embodiments may be configured to optimize the plurality of ensemble model variables and run the ensemble model to create a forecast.

### FIELD OF THE INVENTION

The present application relates generally to systems and methods for creating a forecast utilizing an ensemble forecast model and specifically to simultaneously utilizing a plurality of forecasting models to predict time series data.

### BACKGROUND OF THE INVENTION

Many companies and individuals often wish to forecast sales data, price data, and/or other types of data to better prepare for the future. Accordingly, various types of forecasting methods have been developed. As an example, some forecasting methods include moving average, linear regression, Holt's method, and Box-Jenkins method Autoregressive Integrated Moving Average (ARIMA). While each of these forecasting methods may be utilized to predict future changes to time series data, each has inaccuracies built into the respective algorithms. As such, some forecasting methods may be more suitable for certain types of forecasting than other forecasting methods. Regardless, each single forecasting method often lacks the prediction capabilities as is often desired.

### SUMMARY OF THE INVENTION

Included are embodiments of a system for creating a forecast utilizing an ensemble forecast model. Embodiments include a processor and a memory component that stores logic that, when executed by the processor, causes the processor to receive a user selection of a plurality of models to utilize for forecasting and determine a variable of each of the plurality of models. Additionally, the logic may cause the system to perform the following substantially simultaneously: optimize one or more variables of each of the plurality of models, weight each of the plurality of models according to a predetermined criteria, combine each of the plurality of models into an ensemble model, and run the ensemble model to create a forecast. In some embodiments, optimizing may include selecting a global maximum and/or global minimum from at least one local maximum and/or local minimum. In some embodiments, optimizing one or more variables may include performing nonlinear optimization to determine fixed variables that are optimal for a respective model.

Some embodiments include receiving a selection of a plurality of model families to utilize for forecasting, receiving a selection of a plurality of models to utilize for forecasting, and determining a variable of each of the plurality of models. These embodiments include substantially simultaneously optimizing one or more variables of each of the plurality of models, combining each of the plurality of models into an ensemble model, the ensemble model comprising a plurality of ensemble model variables, and weighting each of the plurality of models according to a predetermined criterion. Still some embodiments may be configured to optimize the plurality of ensemble model variables and run the ensemble model to create a forecast.

Also included are embodiments of a non-transitory computer-readable medium. These embodiments include logic that causes a computing device to receive a selection of a plurality of model families to utilize for forecasting, receive a selection of a plurality of models to utilize for forecasting, and determine a variable of each of the plurality of models. Some embodiments cause the computing device to optimize one or more variables of each of the plurality of models, combine each of the plurality of models into an ensemble model, the ensemble model comprising an ensemble model variable, and weight each of the plurality of models according to a predetermined criterion. Still some embodiments cause the computing device to optimize the ensemble model variable and run the ensemble model to create a forecast.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate various embodiments described herein, and together with the description serve to explain the principles and operations of the claimed subject matter.

FIG. 1 depicts a computing device for creating forecasts utilizing an ensemble forecast model, according to embodiments disclosed herein;

FIG. 2 depicts a block diagram illustrating a process for creating forecasts utilizing an ensemble forecast model, according to embodiments disclosed herein;

FIG. 3 depicts a user interface for providing a user options for creating forecasts utilizing an ensemble forecast model, according to embodiments disclosed herein;

FIG. 4 depicts a datasheet illustrating an algorithm utilized for implementing an additive smoothing time series model, according to embodiments disclosed herein;

FIG. 5 depicts a datasheet illustrating an algorithm utilized for implementing a Holt-winters mulplicative smoothing Time Series model, according to embodiments disclosed herein;

FIG. 6 depicts a datasheet illustrating an algorithm for creating forecasts utilizing an ensemble forecast model, according to embodiments disclosed herein;

FIG. 7 depicts a flowchart for creating forecasts utilizing an ensemble forecast model, according to embodiments disclosed herein; and

FIG. 8 depicts a flowchart outputting a forecast form an ensemble predictive model, according to embodiments disclosed herein.

### DETAILED DESCRIPTION OF THE INVENTION

Embodiments disclosed herein include systems and methods for combining predictive models and simultaneously optimizing the predictive models to create an ensemble predictive model. The ensemble predictive model may be utilized to predict future events with accuracy significantly greater than any of the models utilized in the combination.

Time series data is time spaced in substantially regular intervals (such as sales of a product over time). The need to accurately forecast future instances of this data is of great interest for businesses and other entities. There are many known forecasting methods including but not limited to moving average, linear regression, Holt's method, Box-Jenkins method Autoregressive Integrated Moving Average (ARIMA), etc. With increased computing power now available, substantial progress has been made in automated forecasting systems. Some of these systems can rapidly create thousands to millions of forecasts using the referenced methods.

One embodiment disclosed herein includes a method for weighting a plurality of forecasting methods while simultaneously optimizing one or more variables of each forecasting method in the ensemble. Specifically, a user may determine which time series is going to be forecasted. As an example, the time series may depict various consumer product demands from various geographies. For each of these, embodiments may be configured for collecting historic time series data. The observations of each series should be substantially evenly spaced e.g., monthly, weekly, daily, etc. The potential periodicity of the time series should be noted. For example, monthly data could have a 12 observation periodicity, etc. The number of observations for each time series can vary, but 40 or more observations is common.

Additionally, a determination may be made regarding which forecasting models will be utilized. These may include six month weighted moving average of the monthly growth, twelve month weighted seasonality, additive smoothing, multiplicative smoothing, exponential smoothing, Holt's Method for double exponential smoothing, Holt-Winters Method for additive smoothing, Holt-Winters Method for multiplicative smoothing, seasonality and trend, seasonality linear regression, inflation rate linear regression, autoregressive moving average, (ARMA), autoregressive integrated moving average (ARIMA), autoregressive moving average with exogenous inputs (ARMAX), etc. Each of these models can have from zero to many variables, which can be optimized to give the best fit for that model to the collected historic time series data.

Once the models are determined, the variables of each model may be optimized and simultaneously combined into an ensemble forecast model that will result in fixed variables that are optimal with respect to that model. These variables of the optimization then become the starting value or seed value for the optimization of the ensemble predictive model. The ensemble predictive model may be optimized and run to provide the desired forecast.

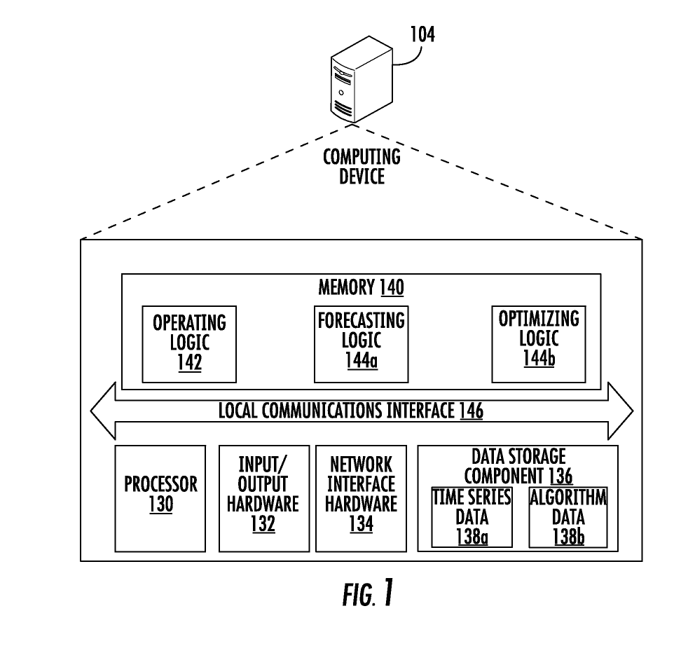

Referring now to the drawings, FIG. 1 depicts a computing device 104 for creating forecasts utilizing an ensemble forecast model, according to embodiments disclosed herein. In the illustrated embodiment, the computing device 104 includes a processor 130, input/output hardware 132, network interface hardware 134, a data storage component 136 (which stores time series data 138a and algorithm data 138b), and the memory component 140. The memory component 140 includes hardware and may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular embodiment, a non-transitory computer-readable medium may reside within the computing device 104 and/or external to the computing device 104.

Additionally, the memory component 140 may be configured to store operating logic 142, the forecasting logic 144a, and the optimization logic 144b, each of which may be embodied as a computer program, firmware, and/or hardware, as an example. A local communications interface 146 is also included in FIG. 1 and may be implemented as a bus or other interface to facilitate communication among the components of the computing device 104.

The processor 130 may include any hardware processing component operable to receive and execute instructions (such as from the data storage component 136 and/or memory component 140). The input/output hardware 132 may include and/or be configured to interface with a monitor, keyboard, mouse, printer, camera, microphone, speaker, and/or other device for receiving, sending, and/or presenting data. The network interface hardware 134 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the computing device 104 and other computing devices.

Similarly, it should be understood that the data storage component 136 may reside local to and/or remote from the computing device 104 and may be configured to store one or more pieces of data for access by the computing device 104 and/or other components. In some embodiments, the data storage component 136 may be located remotely from the computing device 104 and thus accessible via a network. In some embodiments however, the data storage component 136 may merely be a peripheral device, but external to the computing device 104.

Included in the memory component 140 are the operating logic 142, the forecasting logic 144a, and the optimizing logic 144b. The operating logic 142 may include an operating system and/or other software for managing components of the computing device 104. It should be understood that the components illustrated in FIG. 1 are merely exemplary and are not intended to limit the scope of this disclosure. While the components in FIG. 1 are illustrated as residing within the computing device 104, this is merely an example. In some embodiments, one or more of the components may reside external to the computing device 104.

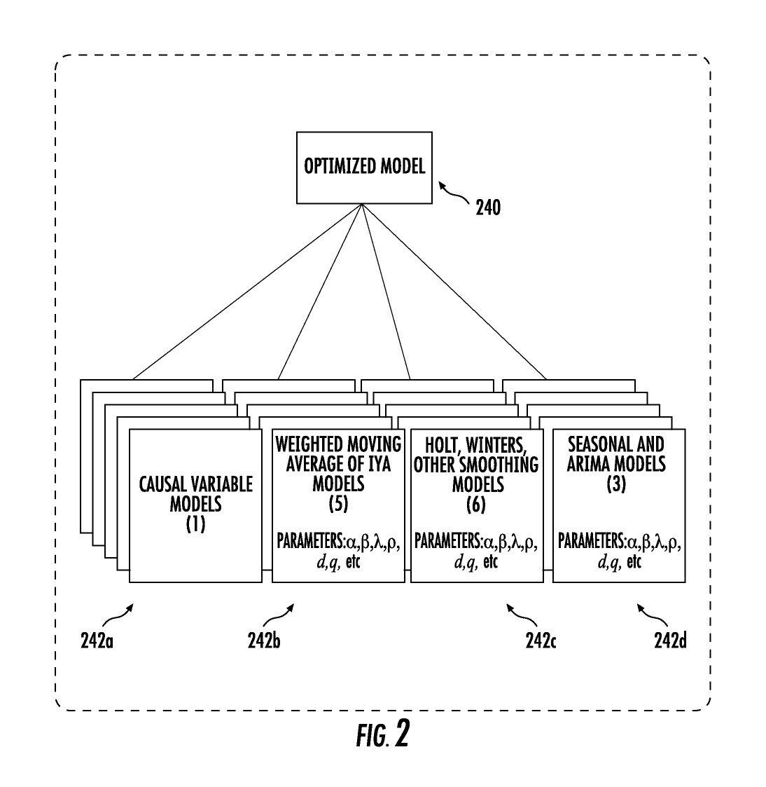

FIG. 2 depicts a block diagram illustrating a process for creating forecasts utilizing an ensemble forecast model, according to embodiments disclosed herein. As illustrated, while some combinatory forecasting models may utilize a plurality of single forecasting models, embodiments disclosed herein may be configured to substantially simultaneously optimize the variables of each of the plurality of models, weight each of the plurality of models according to a predetermined criteria and combine each of the plurality of models into an ensemble model. Specifically, the embodiment of FIG. 2 illustrates that one or more causal variable models 242a may be utilized, along with one or more weighted moving average models 242b, one or more smoothing models, one or more seasonal and ARIMA models, and/or one or more other models. Two or more of these models may each be individually optimized, and then combined and optimized substantially simultaneously to create a single optimized forecasting model, as described in more detail below.

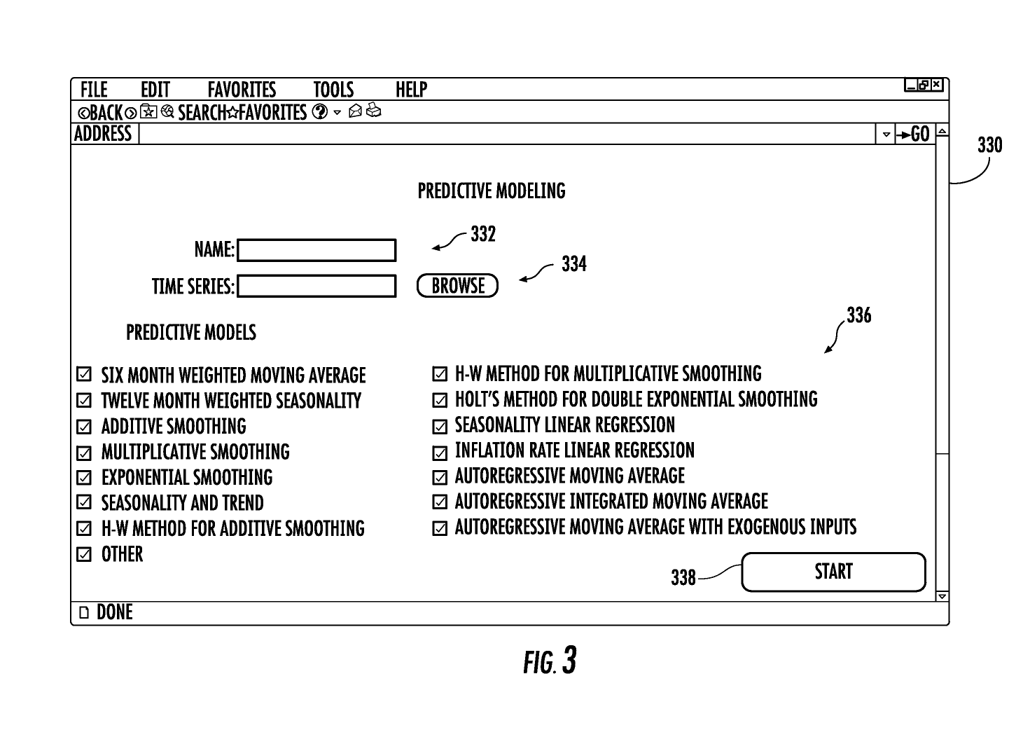

FIG. 3 depicts a user interface 330 for providing a user options for creating forecasts utilizing an ensemble forecast model, according to embodiments disclosed herein. As illustrated, the user interface 330 may provide a user with options for creating and/or initiating a custom ensemble forecasting model. As example, a user may create the custom ensemble model by first populating a name field 332. The name field 332 may be utilized for later retrieval, if the user wishes to update the time series data, rerun the model, and/or view previous results. Additionally, the user may upload or otherwise load a time series for forecasting by populating the time series field 334. The user may then select one or more forecasting models in the models section 336 to include in the ensemble forecasting model. The forecast may be initiated by selecting a start option 338.

Upon selecting the start option 338, the computing device 104 may optimize each of the selected forecasting models. Additionally, the computing device 104 may determine a variable of each of the plurality of models. The computing device 104 may then substantially simultaneously optimize the variables of each of the plurality of models, weight each of the plurality of models according to predetermined criteria and combine each of the plurality of models into an ensemble model. Upon combining the plurality of models, the computing device 104 may run the ensemble model to create a forecast.

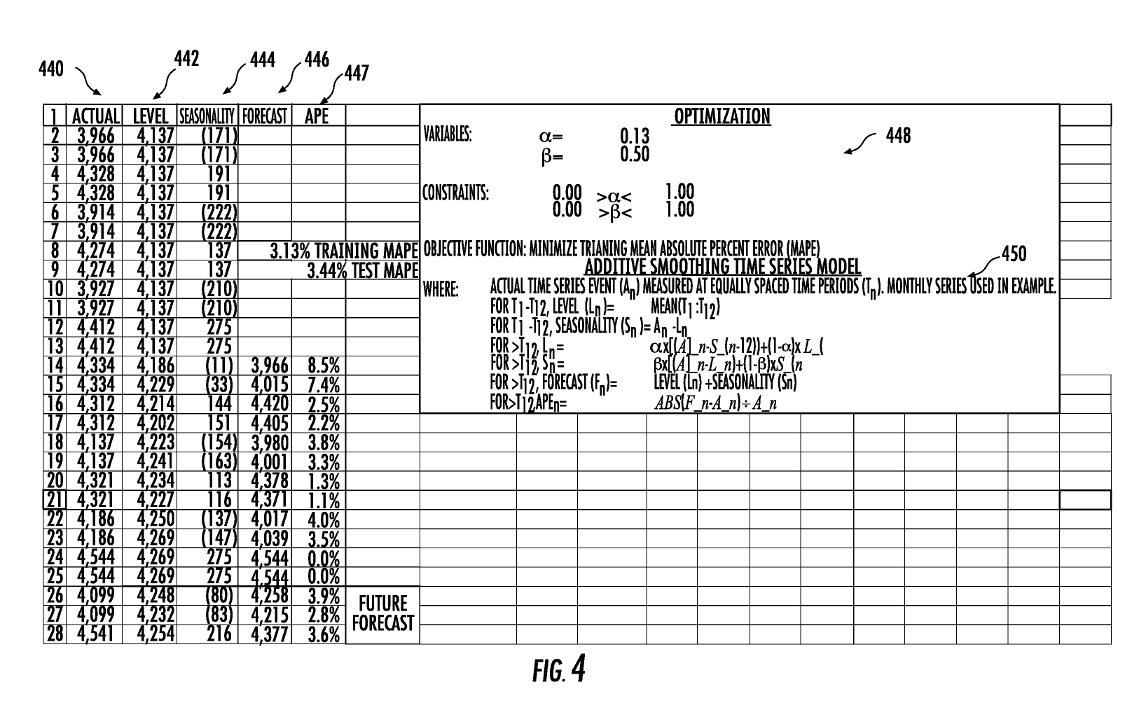

FIG. 4 depicts a datasheet illustrating an algorithm utilized for implementing an additive smoothing time series model, according to embodiments disclosed herein. As illustrated in FIG. 4, the computing device 104 may upload, receive, and/or determine time series data for forecasting. The time series data is provided in time series column 440. Specifically, the time series column 440 includes 24 entries that have been gathered from historical time series data. Also included is a level column 442, a seasonality column 444, a forecast column 446, and an error column 447. As illustrated in optimization section 448, variables may be defined for the selected forecasting model. Specifically, the additive smoothing time series model utilized in this example utilizes α and β variables in the calculation. Depending on the particular time series data, values for these variables may yield different levels of predictive accuracy. In the example of FIG. 4, α has been assigned a value of 0.13. Similarly, β is assigned a value of 0.50. Constraints are also defined in the optimization section 448. The constraints in FIG. 4 are that α must be less than 1.00, but greater than 0. β must be less than 1.00, but greater than 0. It should be understood that in some embodiments, the constraints are fixed by the model, some embodiments may be configured for the user to define the constraints and/or for the computing device 104 to determine the best range of values to use for the constraints.

Also included in FIG. 4 is a forecasting model section 450. The forecasting model section 450 sets forth the one or more models utilized in the forecast. In the example of FIG. 4, an additive smoothing time series model is used for the associated forecast. Accordingly, the actual time series event Aₙ is measured at substantially equally spaced time periods Tₙ, such as in monthly increments. Additionally, the model defines the following:

For T₁−T₁₂, Level (Lₙ)=Mean (T₁:T₁₂);

For T₁−T₁₂, Seasonality (Sₙ)=Aₙ−Lₙ;

For>T₁₂, Lₙ=α×[(A]_{—}n−S_(n−12))+(1−α)×L_(n−1);

For>T₁₂, Sₙ=β×[(A)]_{—}n−L_{—}n)+(1−β)×S_(n−12);

For>T₁₂, Forecast (Fₙ)=Level (Ln)+Seasonality (Sn);

For>T₁₂, APEₙ=(F_{—}n−A_{—}n)÷A_{—}n.

According to the equations in the forecasting model section 450, values for the level column 442, the seasonality column 444, and the forecast column 446 are defined. As illustrated, the computing device 104 utilizes the time series values from the time series column 440 into the equations in the forecasting model section 450. From this, the computing device 104 can determine values for level, seasonality, forecast, and APE. These values may be determined for the first 24 time series values (historical time series data). The model may be run for the historical time series data and the APE (and/or other error calculation) may be determined. Based on the APE, the computing device 104 may optimize the variables, such as α and β to provide the most accurate forecast for the future values, in rows 25-27, based on the reduced APE for the historical time series data. As the actual time values for the future values are realized, the values in rows 25-27 may be computed and forecasting may be performed for other future values.

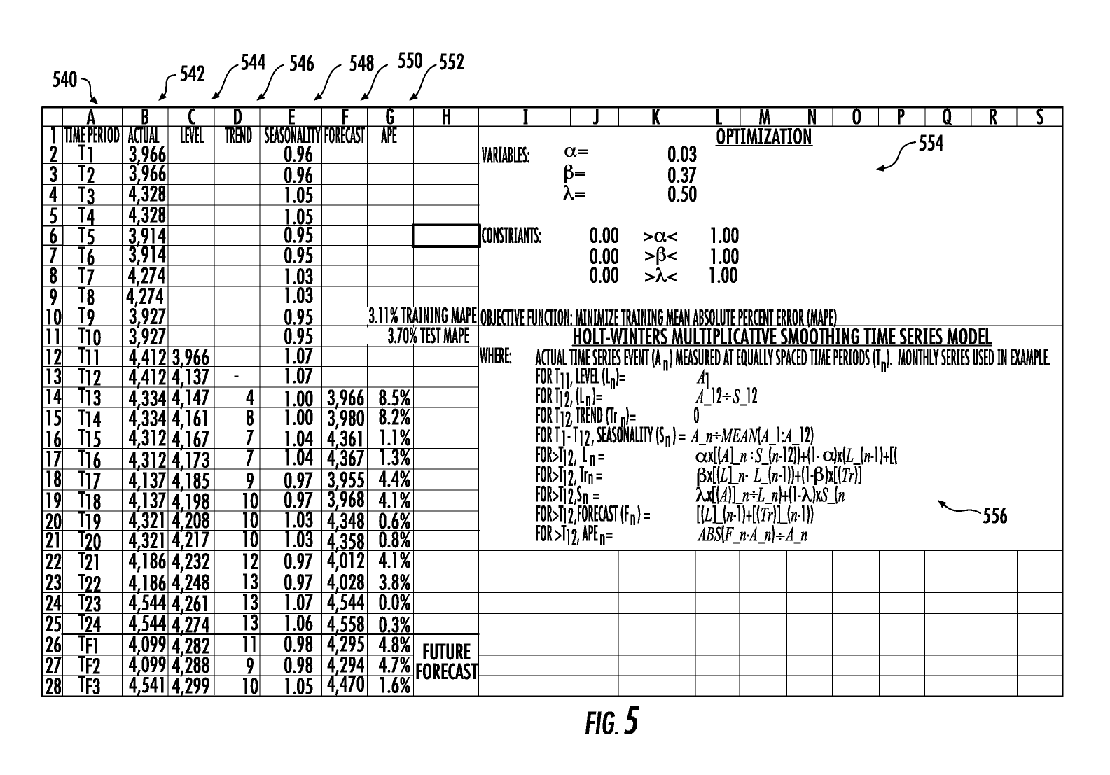

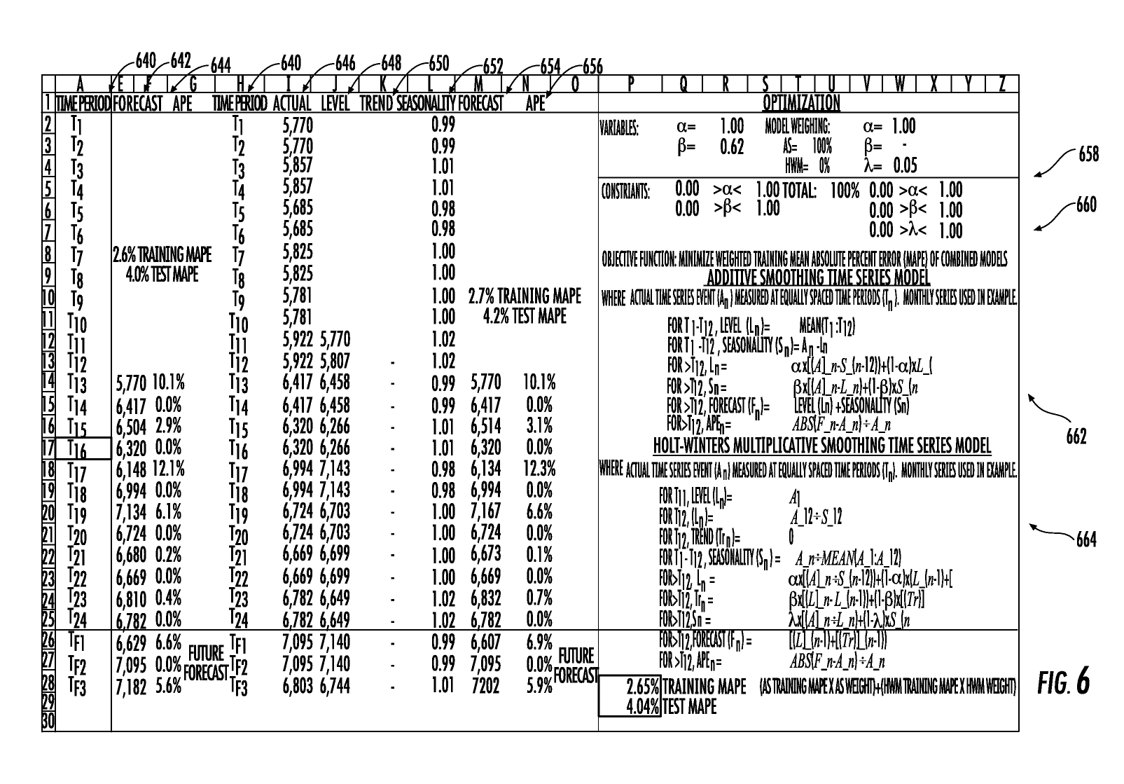

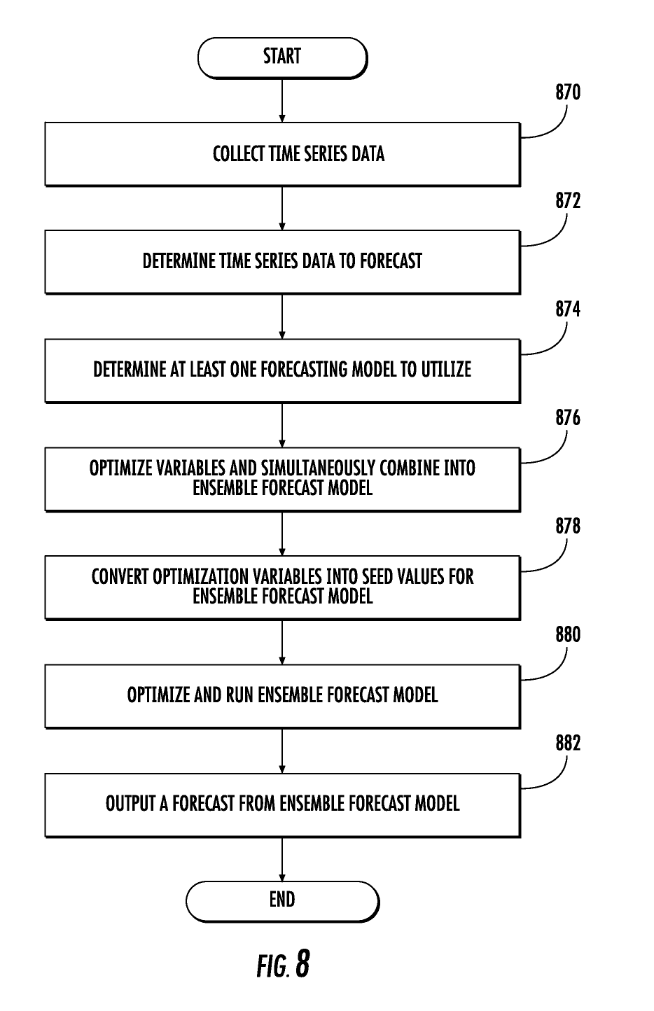

It should be understood that in some embodiments, the datasheet of FIG. 4 may be provided as a user interface to the user for viewing all of the information related to the forecast. Accordingly, in response to selection of the start option 338 from FIG. 8, the user interface from FIG. 4 may be provided. However, some embodiments may be configured such that the datasheet of FIG. 4 is not provided to a user, but is provided herein as an insight for the mechanism for forecasting time series data. In such an embodiment, a separate user interface may be provided to the user that includes some or all of the information provided in FIG. 4. Similarly, the datasheets of FIGS. 5 and 6 may be similarly provided.

FIG. 5 depicts a datasheet illustrating an algorithm utilized for implementing a Holt-winters mulplicative smoothing time series model, according to embodiments disclosed herein. Similar to the datasheet of FIG. 4, the datasheet of FIG. 5 includes a time period column 540, an actual value column 542, a level column 544, a trend column 546, a seasonality column 548, a forecast column 550, and an APE column 552. As discussed above, the actual value column 542 may include 24 values that have been actually realized. Also included in the datasheet of FIG. 5 is an optimization section 554, which defines variables α, β, and λ, which currently have values 0.03, 0.37, and 0.50, respectively. Also included in the optimization section 554 are constraints for the variables. In this embodiment, α, β, and λ, must all be between 0 and 1.00, exclusive.

The datasheet of FIG. 5 also includes a forecasting model section 556, which defines one or more algorithms for the forecasting model. As illustrated, the following equations may be utilized:

For T₁₁, Level (Lₙ)=A₁;

For T₁₂, (Lₙ)=A_{—}12÷S_{—}12;

For T₁₂, Trend (Trₙ)=0;

For T₁−T₁₂, Seasonality (Sₙ)=A_{—}n÷(A_{—}1:A_{—}12);

For>T₁₂, Lₙ=α× [symbol] A [symbol] _{—}n÷S_(n−12))+(1−α)×(L_(n−1)+<Tr [symbol] _(n−1));

For>T₁₂, Trₙ=β× [symbol] L [symbol] _{—}n−L_(n−1))+(1β)× [symbol] Tr [symbol] _(n−1);

For>T₁₂, Sₙ=λ× [symbol] A [symbol] _{—}n÷L_{—}n)+(1−λ)×S_(n−12);

For>T₁₂, Forecast (Fₙ)= [symbol] L [symbol] _(n−1)+ [symbol] Tr [symbol] _(n−1))×S_(n−12);

For>T₁₂, APEₙ=(F_{—}n−A_{—}n)÷A_{—}n.

As illustrated above, the equations utilized for the datasheet of FIG. 5 may be utilized to implement the Holt-Winters Multiplicative Smoothing Time Series Model. Accordingly, while the datasheet of FIG. 4 included seasonality, the data sheet of FIG. 5 includes level, trend, and seasonality as factors of the model. Similar to the datasheet of FIG. 4, the datasheet of FIG. 5 illustrates that the historical time series data may be utilized as training to determine the accuracy of the model for this set of data. Accordingly, a mean absolute percent error (MAPE) or other error metric may be calculated when determining the accuracy and optimizing the model for minimizing error. Minimizing error may include determining a statistic of fitness to the historic time series data, which may include absolute percent error (APE), mean square error (MSE), root mean square error (RMSE), mean absolute percent error (MAPE) and/or other similar error metrics. Optimization may include altering one or more of the variables α, β, and λ within the constraints, based on the known time series data. Once the MAPE and/or APE are determined to meet a predetermined threshold (or are below a predetermined threshold), the model may be utilized for forecasting future data. Additionally, as actual time series data for the time periods is received, this information may be further utilized to optimize the model and/or reduce the error.

FIG. 6 depicts a datasheet illustrating an algorithm for creating forecasts utilizing an ensemble forecast model, according to embodiments disclosed herein. While the datasheets of FIGS. 4 and 5 each utilized a single forecasting model, the datasheet of FIG. 6 illustrates an embodiment that utilizes a plurality of forecast models to create an ensemble forecasting model to predict future time series data. As illustrated, the datasheet of FIG. 6 includes time period columns 640, a first forecast column 642, a first APE column 644, an actual value column 646, a level column 648, a trend column 650, a seasonality column 652, a second forecast column 654, and a second APE column 656.

Also included in FIG. 6 are an optimization section 658, a constraints section 660, a first time series model section 662, and a second time series model section 664. While the datasheets from FIGS. 4 and 5 included variables such as αand β, and α, β, and λ, respectively and FIG. 6 utilizes both individual forecasting models from FIGS. 4 and 5, the optimization section 658 includes all of these variables. Additionally, because a plurality of individual forecasting models is utilized in this forecast, a weighting value is also provided. In some embodiments the computing device 104 may automatically determine the weighting among two or more different individual forecasting models, based on the prediction accuracy, the APE, and/or the MAPE. In some embodiments, the weighting may be selected by a user such as via the user interface 330 from FIG. 3. The constraints section 660 may similarly identify the value ranges for one or more of the variables depicted in the optimization section 658. Additionally the first time series model section 662 provides the equations from the first selected forecasting model (similar to FIG. 4). The second time series model section 664 provides the equations associated with that forecasting model (similar to FIG. 5).

It should be understood that, in addition to utilizing a weighting, embodiments may be configured to create an ensemble model that is a combination of the plurality of individual forecasting models. Accordingly, embodiments may be configured to optimize the variables of the ensemble model for forecasting future time series data. Specifically, some embodiments may be configured to create an ensemble forecasting model and optimize the variables for the individual forecasting models. As discussed above with respect to FIGS. 4 and 5, the variables may be optimized by selecting a value that reduces the error for that particular model. Additionally, the optimized variables for the each individual model may be converted into seed values for the ensemble forecasting model. Based on the mechanism for combining the individual forecasting models, the variable may be altered. The seed values may also be optimized, based on the past time series data and a minimization of the percent error for the ensemble forecasting model.

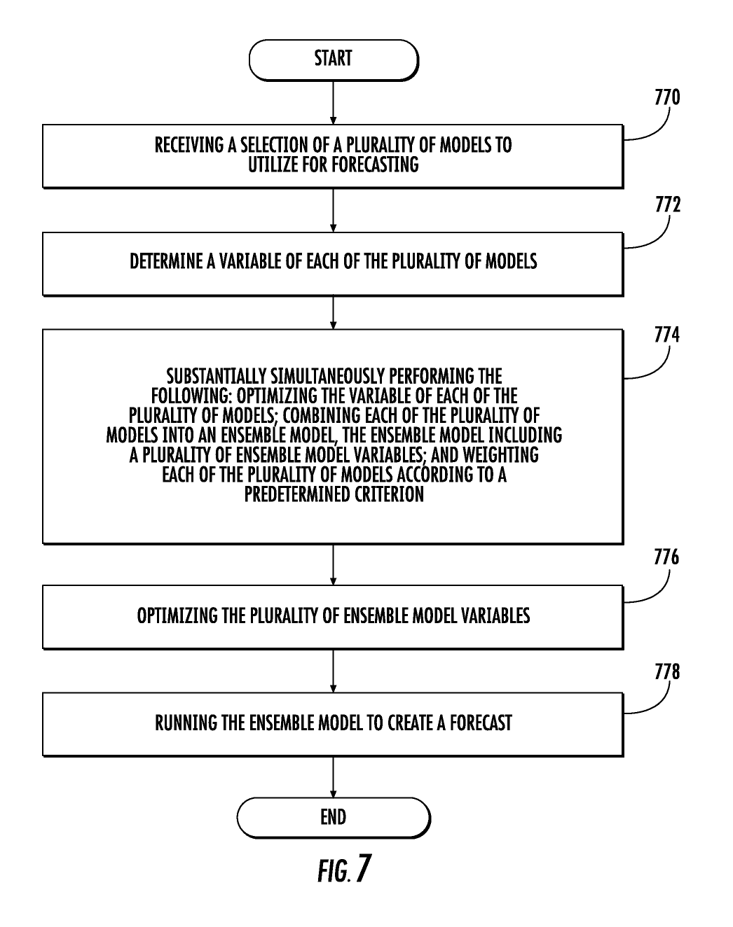

FIG. 7 depicts a flowchart for creating forecasts utilizing an ensemble forecast model, according to embodiments disclosed herein. As illustrated in block 770, a selection of a plurality of model families may be selected for utilizing in forecasting. In block 772, a determination may be made regarding a variable for each of the plurality of models. In block 774, a plurality of actions may be performed substantially simultaneously. Specifically, a variable for at least one of the plurality of models may be optimized. Additionally, at least two of the plurality of models may be combined into an ensemble model, where the ensemble model includes a plurality of ensemble model variables. Additionally, at least one of the plurality of models may be weighted according to a predetermined criterion. In block 776, the plurality of ensemble model variables may be optimized. In block 778, the ensemble model may be run to create a forecast.

FIG. 8 depicts a flowchart outputting a forecast form an ensemble predictive model, according to embodiments disclosed herein. As illustrated in block 870, time series data may be collected. In block 872, a determination may be made regarding the time series data to forecast. In block 874, at least one forecasting model may be determined and/or selected for utilization. In block 876, variables may be operation and substantially simultaneously combined into an ensemble forecast model. In block 878, optimization variables may be converted into seed values for an ensemble predictive model. In block 880, the ensemble forecast model may be optimized and run. In block 882, the forecast from the ensemble forecast model may be output for display.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A system for creating a forecast utilizing an ensemble forecast model comprising:
a processor; and
a memory component that stores logic that, when executed by the processor, causes the processor to perform at least the following:
receive a user selection of a plurality of models to utilize for forecasting;
determine a variable for each of the plurality of models;
substantially simultaneously perform the following:
optimize the variable of each of the plurality of models;
weight each of the plurality of models according to a predetermined criteria; and
combine each of the plurality of models into an ensemble model; and
run the ensemble model to create a forecast.

2. The system of claim 1, wherein optimizing the variable of each of the plurality of models comprises performing a nonlinear optimization to determine fixed variables that are optimal for a respective model.

3. The system of claim 2, wherein optimizing further comprises selecting at least one of the following as an optimized variable: a local minimum and a global minimum.

4. The system of claim 1, wherein the plurality of models includes at least two of the following: a six month weighted moving average of monthly growth, a twelve month weighted seasonality, additive smoothing, multiplicative smoothing, exponential smoothing, Holt's method for double exponential smoothing, Holt-Winters method for additive smoothing, seasonality and trend, Holt-Winters method for multiplicative smoothing, seasonality and trend, seasonality linear regression, inflation rate linear regression, an autoregressive moving average, (ARMA), an autoregressive integrated moving average (ARIMA), and an autoregressive moving average with exogenous inputs (ARMAX).

5. The system of claim 1, wherein the logic further causes the processor to generate a seed value for the ensemble model, wherein the seed value is generated from optimization of the variable.

6. The system of claim 1, wherein the logic further causes the processor to collect historic time series data related to at least one of the plurality of models.

7. The system of claim 1, wherein the logic further causes the processor to minimize error of the ensemble model as a statistic of fitness to historic data and wherein the statistic of fitness comprises at least one of the following: absolute percent error (APE), mean square error (MSE), root mean square error (RMSE), and mean absolute percent error (MAPE).

8. A method for creating a forecast utilizing an ensemble forecast model comprising:
receiving a selection of a plurality of model families to utilize for forecasting;
receiving a selection of a plurality of models to utilize for forecasting;
determining a variable of each of the plurality of models;
substantially simultaneously performing the following:
optimizing the variable of each of the plurality of models;
combining each of the plurality of models into an ensemble model, the ensemble model comprising a plurality of ensemble model variables; and
weighting each of the plurality of models according to a predetermined criterion;
optimizing the plurality of ensemble model variables; and
running the ensemble model to create a forecast.

9. The method of claim 8, wherein optimizing the variable of each of the plurality of models comprises performing a nonlinear optimization to determine fixed variables that are optimal for a respective model.

10. The method of claim 9, wherein optimizing further comprises selecting at least one of the following as an optimized variable: a local minimum and a global minimum.

11. The method of claim 8, wherein the plurality of models includes at least two of the following: six month weighted moving average of monthly growth, twelve month weighted seasonality, additive smoothing, multiplicative smoothing, exponential smoothing, Holt's method for double exponential smoothing, Holt-Winters method for additive smoothing, seasonality and trend, Holt-Winters method for multiplicative smoothing, seasonality and trend, seasonality linear regression, inflation rate linear regression, autoregressive moving average, (ARMA), autoregressive integrated moving average (ARIMA), and autoregressive moving average with exogenous inputs (ARMAX).

12. The method of claim 8, further comprising generating a seed value for the ensemble model, wherein the seed value is generated from optimization of the variable.

13. The method of claim 8, further comprising collecting historic time series data related to at least one of the plurality of models.

14. The method of claim 8, further comprising minimizing error of the ensemble model as a statistic of fitness to historic data; wherein the statistic of fitness comprises at least one of the following: mean square error (MSE), root mean square error (RMSE), and mean absolute percent error (MAPE).

15. A non-transitory computer-readable medium for creating a forecast utilizing an ensemble forecast model that stores logic that causes a computing device to perform the following:
receive a selection of a plurality of model families to utilize for forecasting;
receive a selection of a plurality of models to utilize for forecasting;
determine a variable of each of the plurality of models;
optimize the variable of each of the plurality of models;
combine each of the plurality of models into an ensemble model, the ensemble model comprising an ensemble model variable;
weight each of the plurality of models according to a predetermined criterion;
optimize the ensemble model variable; and
run the ensemble model to create a forecast.

16. The non-transitory computer-readable medium of claim 15, wherein optimizing the variable of each of the plurality of models comprises performing a nonlinear optimization to determine fixed variables that are optimal for a respective model and wherein optimizing further comprises selecting at least one of the following as an optimized variable: a local minimum and a global minimum.

17. The non-transitory computer-readable medium of claim 15, wherein the plurality of models includes at least two of the following: six month weighted moving average of monthly growth, twelve month weighted seasonality, additive smoothing, multiplicative smoothing, exponential smoothing, Holt's method for double exponential smoothing, Holt-Winters method for additive smoothing, seasonality and trend, Holt-Winters method for multiplicative smoothing, seasonality and trend, seasonality linear regression, inflation rate linear regression, autoregressive moving average, (ARMA), autoregressive integrated moving average (ARIMA), and autoregressive moving average with exogenous inputs (ARMAX).

18. The non-transitory computer-readable medium of claim 15, wherein the logic further causes the computing device to generate a seed value for the ensemble model, wherein the seed value is generated from optimization of the variable.

19. The non-transitory computer-readable medium of claim 15, further comprising collecting historic time series data related to at least one of the plurality of models.

20. The non-transitory computer-readable medium of claim 15, wherein the logic further causes the computing device to minimize error of the ensemble model as a statistic of fitness to historic data; wherein the statistic of fitness comprises at least one of the following: mean square error (MSE), root mean square error (RMSE), and mean absolute percent error (MAPE).
